(19) United States
(12) Patent Application Publication
(10) Pub. No.: US 2023/0308753 A1
(43) Pub. Date: Sep. 28, 2023

(54) CAMERA SYSTEM FOR FOCUSING ON AND TRACKING OBJECTS

(71) Applicant: Meta Platforms Technologies, LLC, Menlo Park, CA (US)

(72) Inventors: Yang Wang, Fremont, CA (US); Sweta Kothari, Fremont, CA (US)

(21) Appl. No.: 17/497,656

(22) Filed: Oct. 8, 2021

(51) Int. Cl. G06F 3/01; G06T 7/70; H04N 5/247; H04N 5/232

(52) U.S. Cl. CPC H04N 5/23212; G06F 3/016; G06T 7/70; H04N 5/247; G06T 2207/10016; G06T 2207/30244

(57) ABSTRACT

A headset is described wherein the headset comprise a first camera and a controller. The controller is configured to receive an instruction to generate a video having a focus on an object. The controller identifies a position of the object in a first video frame that is captured by the first camera. The controller generates the video by determining that the object is out of focus in the first video frame based on the position of the object within the first video frame. The controller adjusts the position of the object within the first video frame and incorporates the first video frame in the video.

### FIELD OF THE INVENTION

This disclosure relates generally to artificial reality systems, and more specifically to object tracking methods for artificial reality systems.

### BACKGROUND

In some situations, it may be beneficial to record video of what a person is seeing. For example, a student in a lecture may want to record a video of the professor or a blackboard for later viewing. Cameras on headsets or glasses can record video of what is going on in front of the user. However, if the user moves, such as the student looking away from the blackboard to take notes or get something out of their backpack, the desired subject of the video, the blackboard, may move out of the field of view of the cameras on these devices. In another example, the object of interest may move. The relative movements between the object of interest and the camera worn by the user may result in a disjointed video that may not keep the object in focus within the frame.

### SUMMARY

Embodiments relate to tracking and focusing on objects using a camera system. The camera system may include multiple cameras or a single wide-angle camera and be hosted on a wearable device, such as a headset.

The headset includes at least a first camera and a controller. The controller is configured to receive instructions to generate a video focused on an object. This instruction may originate, for example, from a user input to the headset or a mobile device in communication with the headset indicating an object to focus on. The controller identifies the position of the object in a first video frame generated by the first camera and determines that the object is out of focus in the first video frame based on the position. The controller adjusts the position of the object within the first video frame and incorporates the first video frame into the video.

Adjusting the position of the object within the first video frame may involve modifying the first video frame, such as via cropping. In some embodiments, the controller incorporates a second video frame that includes the object, the second video frame generated by aa second camera of the headset when the object is outside of a field of view of the first camera.

The method of tracking objects with the camera system comprises, receiving, by a headset, an instruction to generate a video having a focus on an object. A position of the object is identified in a first video frame captured by a first camera. A video is generated by determining that the object is out of focus in the first video frame based on the position of the object in the first video frame. The position of the object within the first video frame is adjusted, and the first video frame is incorporated into the video.

A non-transitory computer-readable medium comprising stored instructions that when executed by one or more processors configure the one or more processors to receive instructions to generate a video having a focus on an object. The processors then identify a position of the object in a first video frame captured by a first camera. A video is generated by the first camera and the processors by determining that the object is out of focus in the first video frame and adjusting the position of the object within the first video frame. The first video frame is incorporated into the video.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a head-mounted display, in accordance with one or more embodiments.

FIG. 2 is a block diagram of a camera system, in accordance with one or more embodiments.

FIG. 3 is a flowchart illustrating a process for object tracking with multiple cameras, in accordance with one or more embodiments.

FIG. 4 is an illustration of a modified video frame for tracking an object.

FIG. 5 is a diagram illustrating a use case for the process for object tracking with multiple cameras, in accordance with one or more embodiments.

FIG. 6 is a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Embodiments relate to identifying, tracking, and recording objects using one or more imaging devices. A camera system generates a video having a focus on a selected object and may modify the video frame to alter the focus of the video captured. In the context of the camera system, an object being “in focus” refers to the object having a good composition within a video frame, such as the object being within a threshold distance of the center of the video frame. As such, an “out of focus” video may display the object with a poor composition, such as beyond the threshold distance from the center of the video frame or outside of the video frame entirely. For each video frame in a generated video, the camera system may modify the video frame such as by cropping the captured video to a modified video frame having the object within a threshold distance from the center of the video frame. When modifying the video frame, the camera system may choose to not include video frames captured by the imaging device (i.e., within the field of view of the imaging device) where the object is outside of the field of view of the imaging device. The camera system may also elect to focus on the object by switching from one imaging device with a first field of view to a second imaging device with a second field of view. This method may be used, for example, to track a moving object that leaves the first field of view and enters (or re-enters) the second field of view and generate a video with video frames captured by multiple imaging devices.

The camera system may be located partially or entirely on a headset, such as smart glasses or a head-mounted display. In some embodiments, one or more imaging devices may be located on the headset while a controller that generates the video may be in a separate device. In some embodiments, the headset may communicate with an external device such as a smart phone, laptop, or smart watch. The external device may execute an application to facilitate operations of the headset, such as providing instructions for control of the headset or providing a display of the video generated by the headset.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

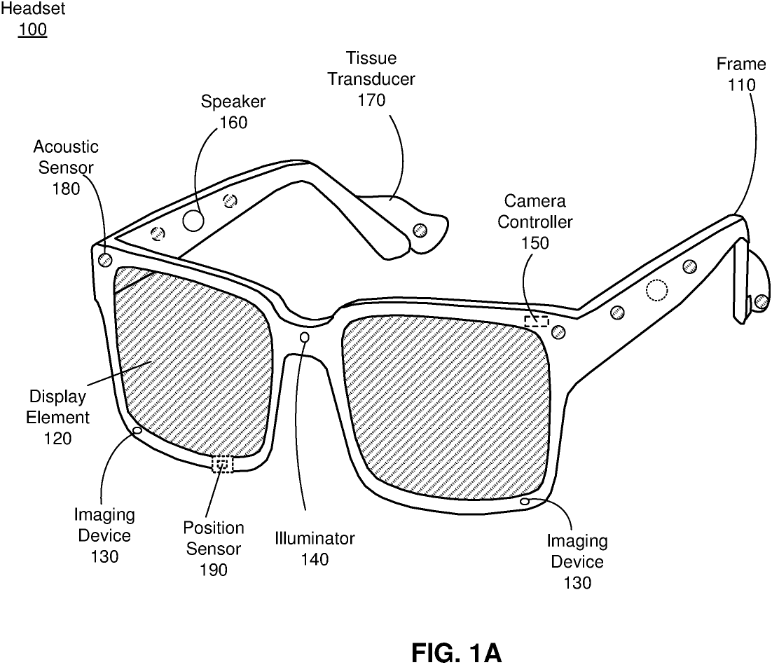

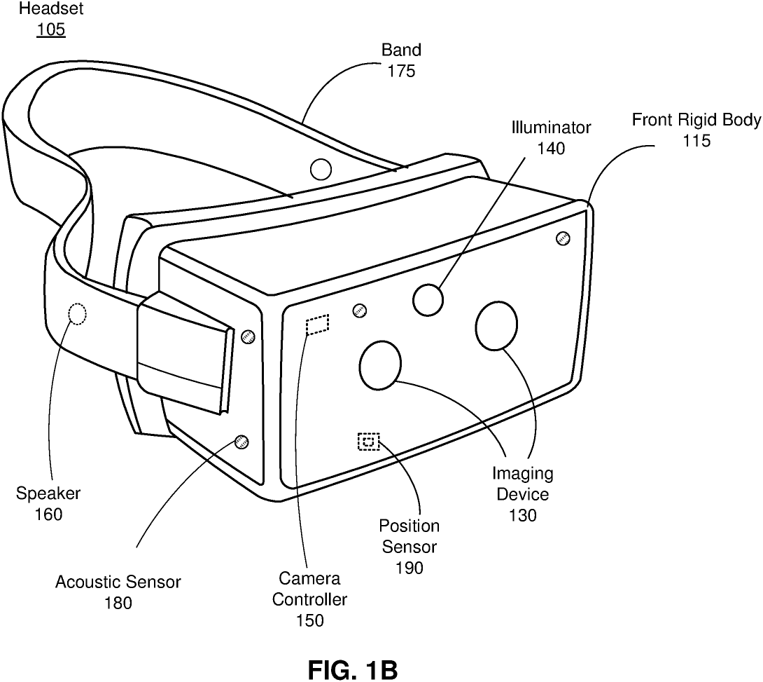

FIG. 1A is a perspective view of a headset 100 implemented as an eyewear device (e.g., smart glasses), in accordance with one or more embodiments. In some embodiments, the eyewear device is a near eye display (NED). In general, the headset 100 may be worn on the face of a user such that content (e.g., media content) is presented using a display assembly and/or a camera system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display elements 120, a depth camera assembly (DCA), a camera system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, ear piece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eyebox. For example, one or both of the display elements 120 may be a lens without correction (non-prescription) or a prescription lens (e.g., single vision, bifocal and trifocal, or progressive) to help correct for defects in a user’s eyesight. In some embodiments, the display element 120 may be polarized and/or tinted to protect the user’s eyes from the sun.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

In some embodiments, the headset 100 may not have a display element 120. For example, in place of the display element 120 may be lenses of glasses through which a user of the headset 100 can see.

The DCA determines depth information for a portion of a local area surrounding the headset 100. The DCA includes one or more imaging devices 130 and a DCA controller (not shown in FIG. 1A) and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The DCA may include an eye tracking unit that determines eye tracking information. The eye tracking information may comprise information about a position and an orientation of one or both eyes (within their respective eye-boxes). The eye tracking unit may include one or more cameras. The eye tracking unit estimates an angular orientation of one or both eyes based on images captures of one or both eyes by the one or more cameras. In some embodiments, the eye tracking unit may also include one or more illuminators that illuminate one or both eyes with an illumination pattern (e.g., structured light, glints, etc.). The eye tracking unit may use the illumination pattern in the captured images to determine the eye tracking information. The headset 100 may prompt the user to opt in to allow operation of the eye tracking unit. For example, by opting in the headset 100 may detect, store, images of the user’s any or eye tracking information of the user.

The imaging device 130 may comprise one or more cameras configured to capture images or video of the environment around the headset 100. In some embodiments, the one or more cameras are wide angle cameras. The imaging device 130 may have an associated field of view (FOV) that determines the boundaries of the range in which the device 130 can capture images and video. The headset 100 may include multiple imaging devices 130, each with a different FOV.

In some embodiments, one or more acoustic sensors 180 may be placed in an ear canal of each ear (e.g., acting as binaural microphones). An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The camera controller 150 processes information from the imaging device 130. The camera controller 150 may comprise a processor and a computer-readable storage medium. The camera controller 150 may be configured to generate a video, captured by the imaging device 130, having a focus on a selected object.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

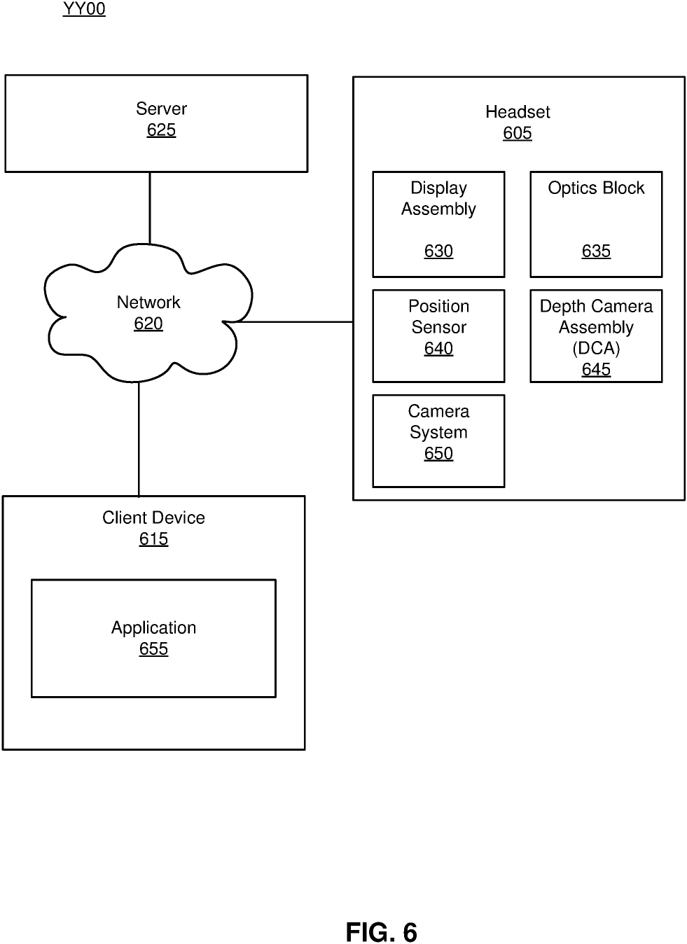

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 6.

The headset 100 includes a camera system that includes one or more imaging devices 130 and the camera controller 150. The imaging device 130 captures images and videos of the local area within the field of view of the imaging device 130. The controller receives an indication of an object in the local area to have a focus on and processes the video captured by the imaging device to keep the object in focus even as the object moves. In some embodiments, the camera system may have multiple imaging devices each with separate fields of view. In the case that the indicated object moves out of one field of view, it may continue to be focused on by an imaging device having a second field of view that contains the indicated object. The camera system may communicate with additional components of the headset 100such as the position sensor to gauge the movement of the wearer of the headset. The camera system may additionally communicate with the display element 120 or speaker 160 to provide a visual or auditory cue to the user. The cue may indicate that a video focused on an object has started or stopped recording, that the object has left the field of view of the camera system, or other statuses of the camera system.

FIG. 1B is a perspective view of a headset 105 implemented as an HMD, in accordance with one or more embodiments. In embodiments that describe an AR system and/or a MR system, portions of a front side of the HMD are at least partially transparent in the visible band (~380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes many of the same components described above with reference to FIG. 1A, but modified to integrate with the HMD form factor. For example, the HMD includes a display assembly, a DCA, a camera system, and a position sensor 190. FIG. 1B shows the illuminator 140, the camera controller 150, a plurality of the speakers 160, a plurality of the imaging devices 130, a plurality of acoustic sensors 180, and the position sensor 190. The speakers 160 may be located in various locations, such as coupled to the band 175 (as shown), coupled to front rigid body 115, or may be configured to be inserted within the ear canal of a user.

Headset 105 of FIG. 1B may also host the camera system described above. The camera system uses components of headset 105 such as the imaging devices 130 and camera controller 150 to generate a video having a focus on an object.

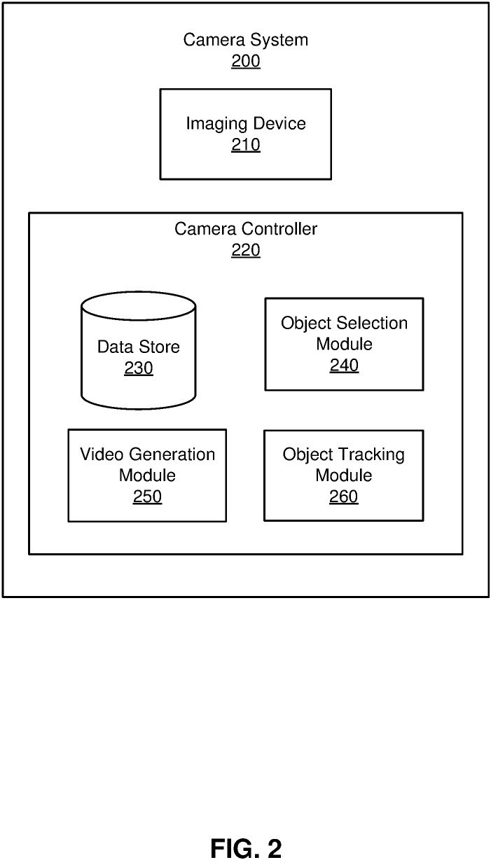

FIG. 2 is a block diagram of a camera system 200, in accordance with one or more embodiments. The camera system described above with reference to FIG. 1A or FIG. 1B may be an embodiment of the camera system 200. The camera system 200 generates a video having a focus on a selected object in the local area. The camera system 200 may receive an indication of an object in the local area to focus on and activate or deactivate one or more imaging devices 210 in response. The imaging device 210 captures video frames of the local area including the indicated object. The camera system 200 modifies the video frame to focus on the indicated object. The camera system 200 includes an imaging device 210 and a camera controller 220. Some embodiments of the camera system 200 have different components than those described here. Similarly, in some cases, functions can be distributed among the components in a different manner than is described here.

The imaging device 210 may be an embodiment of the imaging device 130 on headset 100/105. The imaging device 210 may be one or more cameras. In some embodiments, the imaging device 210 may be one or more wide angle cameras. The imaging device 210 may comprise an array of cameras that are spread across the surface of the headset 100 or 105 to capture FOVs for a wide range of angles in the local area. The imaging device 210 of the camera system 200, or each of the one or more cameras of the imaging device 210, is powered on and off (e.g., activated and deactivated) by the camera controller 220. The imaging device 210, when activated, is configured to capture images or video frames of the local area within its field of view. The field of view (FOV) determines the amount of the local area that the imaging device 210 can capture.

As described herein a wide angle camera may be a camera having a field of view of 47 degrees or more. In typical use, a wide angle camera may be used to capture images of an object that is far away. For example, a wide angle camera may be used at a soccer game to capture images of the entire field such that the ball can be seen as it moves across the field. The ball may, for example, be up to 30 meters away from the wide angle camera. In contrast, a camera having a field of view less than 47 degrees may typically be used to capture images of objects that are close to the camera, such as at 5 meters away (or less).

The imaging device 210, however, may be a wide angle camera that is used to capture nearby objects. As such, the imaging device 210 may capture more of the surroundings of the object than a non-wide angle camera would. The extra field of view of the imaging device 210 allows for the device 210 to focus on a nearby moving object as it moves through a local area without needing to move the camera.

The camera controller 220 is configured to activate the imaging device 210 and process images or video frames captured by the imaging device to enable the camera system 200 to have a focus on an object. Having a focus on an object may involve adjusting the composition of the object within the video frame, such as keeping the object within a certain distance of the center of the video frame. The video frame is what is recorded by an imaging device 210 and used to generate a video presented to a user that has requested for the camera system 200 to focus on an object. In the embodiment of FIG. 2, the camera controller 220 includes a data store 230, an object selection module 240, a video generation module 250, and an object tracking module 260. The camera controller 220 may be located inside a headset, in some embodiments. Some embodiments of the camera controller 220 have different components than those described here. Similarly, functions can be distributed among the components in different manners than described here. For example, some functions of the controller may be performed external to the headset. The user may provide instructions that configure the camera controller 220 to transmit data captured by the headset to systems external to the headset, and the user may select privacy settings controlling access to any such data.

The data store 230 stores data for use by the camera system 200. For example, the data store may store a history of objects that have previously been tracked by the camera system 200. The data store may additionally hold previously captured images, video frames, videos, a library of identified objects, location and time stamp data of recorded video and captured images, biographical information of the user, privacy settings and other preferences of the user, physical information about the user such as height, and other parameters necessary for the camera system 200. In some embodiments the data store 230 may be separate from the camera system 200. The data store 230 may be cloud storage in which data is configured to be transmitted from the headset to a server through a network, as discussed further with reference to FIG. 6. When the headset lacks network connectivity, the data store 230 may act as short-term storage until the headset connects to a network and can upload data stored in the data store 230.

The object selection module 240 receives instructions to generate a video having a focus on an object. The instruction may be generated from a user indicating a selection of an object to be the focus in the video. The user may make this indication such as by pressing a button on the headset while facing toward an object, using an interface of a client device connected to the headset to select an object within the FOV of the system 200 (e.g., a touch screen interface), physically gesturing at the object, using a voice command, or some other way. The instructions may include coordinates of where the desired object is located within the field of view of the camera system and may include image recognition analyses that identify the object.

The object selection module 240 identifies the position of the object in video frames captured by the imaging device 210. Once the object is identified by the object selection module 240 in a video frame, the object selection module 240 defines the location of the object within the field of view of imaging device 210. In some embodiments, the object selection module 240 outputs, to a display device associated with the camera system 200, a visual indication of the object within the field of view. Displaying the visual indication may involve streaming video to a device external to the headset hosting the camera system 200. For example, the camera system 200 may stream the video frame to a client device such as a smart phone or smart watch so that the user can confirm that the object being captured by the imaging device 210. The object selection module 240 may further receive an indication from the client device instructing the camera system 200 to keep an object in focus or confirming that the object is correctly identified. The object may be identified by a recognition system of the object selection module 240. In some embodiments, the object recognition system of the object selection module 240 may be trained to detect specific shapes such that objects of those shapes are most accurately identified. For example, the object selection module 240 may be configured to identify human, animal, and car shapes to improve the accuracy of identifying those objects.

In the case that the object leaves the field of view of the camera system and re-enters, the object selection module 240 may be configured to identify the object upon returning to the field of view such as by comparing the object to a recently tracked object recorded by the data store 230 or recording an identifier of the object to enable re-focusing. Once the object selection module 240 has identified the object and its position within the FOV of the system it may send instructions to the object tracking module 260 to focus on the object.

The video generation module 250 generates a video by adjusting the position of the object within the video frames. The video generation module 250 may receive an indication from the object selection module 240 of the location of the object within the FOV of the imaging device 210. The video generation module 240 adjusts the position of the object within the video frame to focus on the object. Adjusting the position of the object may include modifying the captured video frame, which comprises the whole FOV of the imaging device 210, to a cropped video frame with an improved focus on the object. The video generation module 240 chooses selects portions of the captured video frame to keep or portions of the captured video frame to crop out to improve the focus on the object. The portions of the captured video frame may be chosen to be removed based on the objects distance from the center of the captured video frame. The video generation module 250 adjusts the position of the object such that the object is within a threshold distance of the center of the video frame. The video generation module 250 may communicate with the object tracking module 260 to determine if the object is in focus in the video frame. The video generation module 250 may also adjust the size or resolution of the video frame, such as after cropping the video frame such that all video frames in a video are the same size or resolution. The video generation module 250 may also perform other types of adjustments to each video frame, such as choosing to not include certain video frames in the video or stabilizing the object within video frames of the video.

The object tracking module 260 determines that the object is out of focus in the video frame. The object tracking module 260 may determine the focus by measuring the distance from the object to the center of the video frame. If the object is beyond a threshold distance from the center of the video frame, the object tracking module identifies the object as out of focus and communicates to the video generation module 250 to adjust the position of the object within the video frame.

In the case that the imaging device 210 includes multiple cameras, the object tracking module 260 may indicate to the video generation module which camera to activate and record video frames from to keep the object in focus based on the movement of the object or the headset. The video generation module 250, responsively, activates the indicated camera, provides the captured video frames from the indicated camera to the tracking module 260 for determination regarding whether the object is out of focus, and, if the object is out of focus, adjusts the position of the object within the video frame. In some embodiments, one or more of the imaging devices 210 may move relative to the headset. In the case that the imaging device 210 includes one or more actuatable cameras, the object tracking module 260 may identify a direction in which the camera should be moved to retain focus on the object and transmit the direction to the video generation module 250. The video generation module 250 may then send instructions to an actuation mechanism of the camera based on the direction transmitted by the object tracking module 260.

The object tracking module 260 may instruct the headset or client device to provide an auditory or visual indication in the case that the object is moving or has moved outside of the FOV of the imaging device 210 and thus movement of the headset is needed to retain focus on the object. For example, if a student is using a headset with the camera system 200 to record a lecture they are in, the camera system will need to adjust the position of the lecturer within the video frame each time the student looks down to take notes and looks back up. However, if the student turns away from the lecturer such that the lecturer is outside of the FOV of the system 200, the headset will provide an auditory or visual indication to the user. In another example, the headset may remain stationary while the object moves, causing the object to be out of focus in the video frames. The object and the headset may both move, in a further example, causing the object to be out of focus in the video frames. In each example the camera system 200 adjusts the video frame to keep the object in focus. If the object moves out of the FOV of the system 200, the headset may provide haptic feedback to alert the user to move the headset to keep the object in focus.

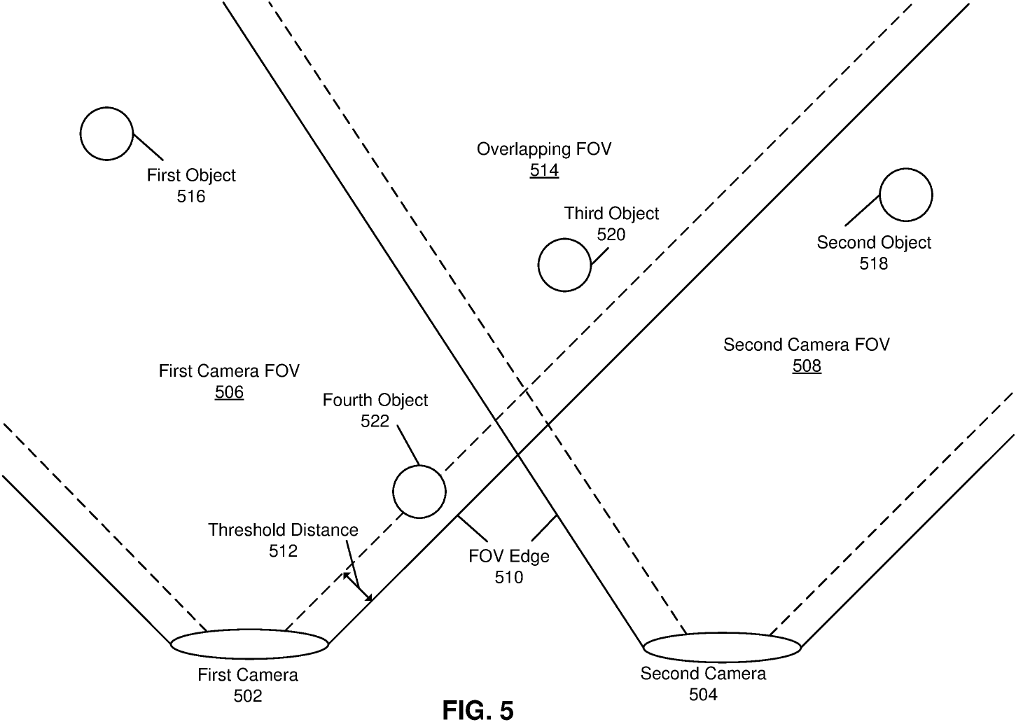

In embodiments with multiple cameras, such as seen in FIG. 5, the object tracking module 260 monitors the position of the object within the FOV of the camera that is currently being used to identify if another camera should be activated. If the object is within a threshold distance of an edge of the FOV of a first camera, and that edge is adjacent to the FOV of a second camera, the object tracking module 260 will indicate to the video generation module 250 to activate the second camera. When the second camera is activated to capture the object, the first camera may be deactivated to converse power of the system. If the object is within a threshold distance of an edge of the second camera FOV that is adjacent to the first camera FOV, both cameras may be powered on (e.g., activated) to ensure that the object is captured as it moved back and forth between the first camera FOV and second camera FOV. In some embodiments a camera may only be deactivated when the object has not been present in the video frame of the camera for a period of time or for a number of video frames. In other embodiments the activation and deactivation of cameras may be based on other characteristics of the system or the object. For example, if the identified object is recorded to have previously been moving quickly or unpredictably, the camera system 200 may keep all cameras active to ensure the object is captured. In some embodiments, a video frame in a video may include combined portions of multiple video frames captured by different cameras.

Changing which camera is used to capture the object helps to ensure that the responsibility of capturing the object in video frames can be successfully passed to different cameras. If the edge that the object is near is not adjacent to the FOV of another camera of the system 200 (e.g., the object is near the edge of the collective FOV of all cameras the system), the object tracking module 260 instructs the headset or client device to provide an auditory or visual indication to the user. This alerts the user to move the headset and cameras to facilitate continuous capture of the object.

The video is compiled by the camera system 200 to include video frames that are focused on the object. For example, the video may include cropped video frames from a first camera for a first portion of the video and, responsive to the object moving into the FOV of the second camera, cropped video framed from a second camera for a second portion of the video. The video frames captured by the camera system 200 may be modified such as to stabilize video such that the object does not move disjointedly in the video. In some embodiments, the video may be editable after it is captured such that a user of the camera system 200 may choose which video frames they would like to be included in the video. The camera system 200 may also store unmodified versions of the captured video frames and display them to a user so that the user may indicate how the video frames should be modified for the video.

The user may opt-in to allow the data store 230 to record data captured by the camera system 200. In some embodiments, the camera system 200 may employ always on recording, in which the camera system 200 records all sounds captured by the camera system 200 in order to improve the experience for the user. The user may opt in or opt out to allow or prevent the camera system 200 from recording, storing, or transmitting the recorded data to other entities.

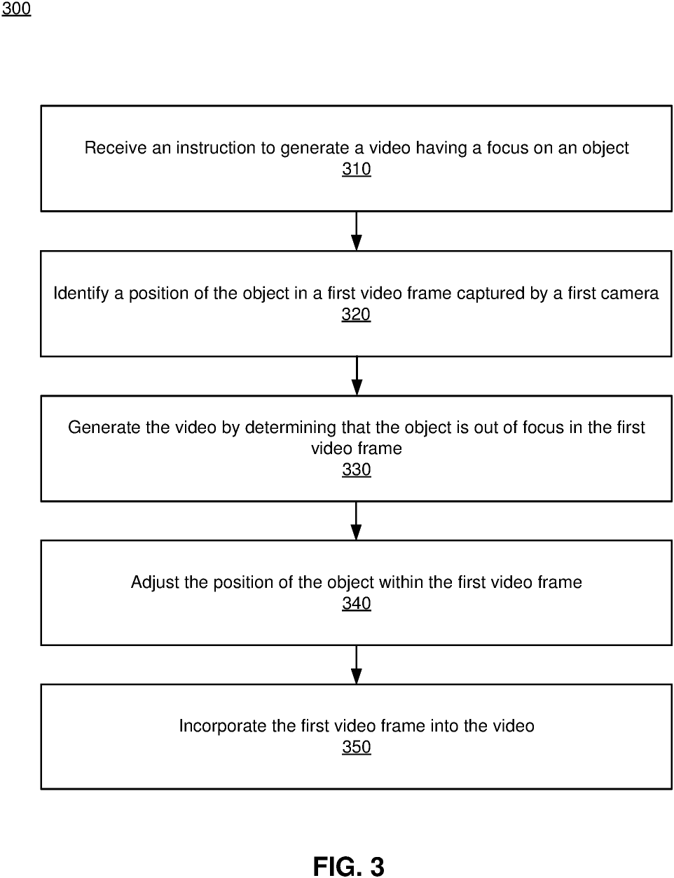

FIG. 3 is a flowchart illustrating a process 300 for object tracking with multiple cameras, in accordance with one or more embodiments. The process 300 shown in FIG. 3 may be performed by components of a camera system (e.g., camera system 200). Other entities may perform some or all of the steps in FIG. 3 in other embodiments. Embodiments may include different and/or additional steps or perform the steps in different orders.

The camera system 200 receives 310 an instruction to generate a video having a focus on an object. The instruction may be originated such as by a user pressing a button on a headset (such as headset 100/105) hosting the camera system to indicate an object to focus on. The instruction may otherwise originate from another form of user input to the camera system.

The camera system 200 identifies 320 a position of the object in a first video frame captured by a first camera. The position of the object may be defined such as by distances the object is away from each edge of the video frame, or a coordinate on a coordinate grid comprising the video frame. The position of the object may be determined via image processing in which the object is identified.

The camera system 200 may generate the video based in part on steps 330-350.

The camera system 200 determines 330 that the object is out of focus in the first video frame. In some embodiments, “out of focus” may mean that the position of the object within the image frame is too far from the center of the image frame. The object being out of focus may be caused by a movement of the object or movement of the camera.

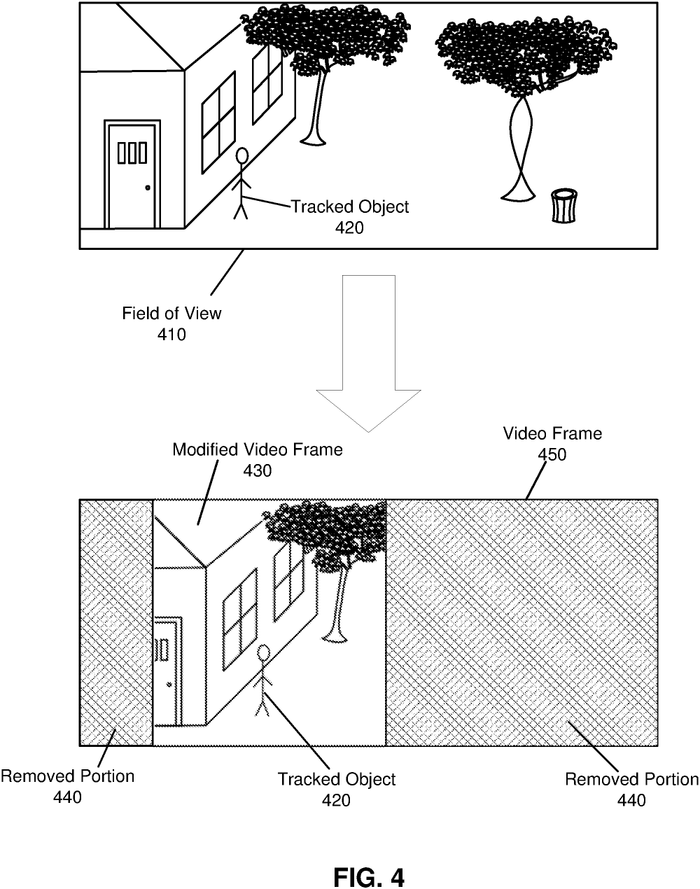

The camera system 200 adjusts 340 the position of the object within the first video frame. The position of the object within the first video frame may be adjusted such as by cropping the video frame to a modified video frame, as seen in FIG. 4, or by switching which camera is capturing video of the object, as seen in FIG. 5. Adjusting the position of the object within the first video frame may be done such that the object is within a threshold distance of a center of the first video frame.

The camera system 200 incorporates the first video frame into the video. Once the object is in focus in the first video frame, the first video frame is added to the video. The final video may be a collection of video frames in which the object is in focus (e.g., within a threshold distance from a center of the video frame). The position of the object within some or all of the video frames of the video may be adjusted.

In some embodiments, the controller of the camera system may be configured to generate the video by incorporating video frames captured by multiple cameras. Each video frame may be associated with a period of time in which the video frame was captured. For each period of time, the controller may select a video frame from one or more of the cameras to incorporate into the video. The position of the object in each video frame may also be adjusted.

For example, the camera system may include a second camera. A second video frame generated may be generated by the second camera that includes the object. The second camera may have a second field of view that is different from a first field of view of the first camera. The camera system activates the second camera responsive to the object being within a threshold distance of a first edge of the first video frame. The first edge of the first video frame is adjacent to the second field of view such that activating the second camera may capture the object in focus in the second field of view. In some embodiments, once the object moves outside of the field of view of the first camera, the camera system deactivates the first camera.

The camera system may be configured with a third camera, the third camera having a field of view different from the fields of view of the first and second camera. In response to the object moving to be within a threshold distance of an edge of the second video frame, the edge adjacent to the field of view of the third camera, the camera system may activate a third camera. Likewise, once the object is no longer within the field of view of the second camera, the camera system will deactivate the second camera. However, if the object moves to be within an edge of the second video frame where the edge is adjacent to the field of view of the first camera, the first camera may be activated such that the object is captured within the first video frame. The method of keeping the object in focus is similar across embodiments of the camera system having different numbers of cameras. The camera system activates cameras having the object within their field of view and deactivates cameras that do not have the object within their field of view. The camera system incorporates video frames having the object in focus to the video, the video frames may be from any of the cameras of the camera system that have captured the object.

FIG. 4 is an illustration of a modified video frame for tracking an object. In this example, a parent may be using the camera system to take a video of their child playing in the park and have the camera system focused on the child. Here, the field of view 410 is the total area that can be captured by one or more cameras of the camera system. In some embodiments, the camera system may activate multiple cameras at once to expand the field of view 410. The field of view 410 in this use case contains a building, trees, and a child wherein the child is the tracked object 420. In the field of view 410 of the camera system, the tracked object 420 may be out of focus in that the object 420 is beyond a threshold distance from the center of the field of view 410. In order to gain focus on the tracked object 420, the camera system creates a modified video frame 430. The modified video frame 430 includes the tracked object 420 within the threshold distance from the center of the modified video frame 430. In order to improve the focus on the tracked object 420 the camera system may remove portions of the video frame 450 to create the modified video frame 430. The removed portions 440 of the video frame 450 are not incorporated into the video generated by the camera system. By essentially cropping the field of view 410 to a focused, modified video frame 430, the camera system keeps the tracked object 420 in focus. This type of processing may be performed for each video frame captured over time to generate the video.

Note that while the embodiment shown in FIG. 4 has a camera with a field of view that is wide horizontally and narrow vertically, the field of view of the camera system may comprise any shape. The field of view may be square, circular, polyhedral, or irregularly shaped. The modified video frame 430 may also be shaped in various ways, such as according to a setting chosen by the user.

FIG. 5 is a diagram illustrating object tracking with multiple cameras, in accordance with one or more embodiments. In some embodiments, like the embodiment shown in FIG. 5, the camera system may have multiple cameras to expand the field of view of the system. As a tracked object moves through the field of view of the camera system, the camera system may power on different cameras to capture the object while powering off cameras that cannot capture the object.

In FIG. 5 a first object 516 is indicated to be focused on by the camera system. The camera system may power on all of its cameras, first camera 502 and second camera 504, to initially locate the first object 516. Once the first object 516 has been located within the field of view of the camera system, the camera system may power off any cameras the object 516 is not captured by. In the shown case, the first object 516 is in the first camera FOV 506 and therefore can be focused on using the field of view 506 of just the first camera 502. As such, the first camera 502 may be activated and the second camera 504 may be deactivated to capture the first object 516. The second object 518, similarly, is fully located within the second camera FOV 508 so if the second object 518 was indicated to be focused on the camera system may only power on the second camera 504 and power off first camera 502. In some embodiments, both the first camera 502 and the second camera 504 may remain powered on while the camera system is focused on the second object 518 but the controller of the camera system may only process the video frame from the second camera 504 into a modified video frame as seen in FIG. 4.

In the case of the third object 520 being indicated to be focused on (e.g., tracked), the third object 520 is within the overlapping FOV 514 of the first camera 502 and the second camera 504. Because the third object 520 is within the overlapping FOV 514 it may be tracked using video captured from either the first camera 502 or the second camera 504. In some embodiments in which the first camera 502 and the second camera 504 are non-identical hardware, the camera system may track the third object 520 with which ever camera has a lower power draw to conserve battery of the system.

In the case of the fourth object 522 being indicated to be focused on (e.g., tracked), the first camera 502 may be used to track the fourth object 522 because the fourth object 522 is within the first camera FOV 506. However, because the fourth object 522 is within a threshold distance 512 of the FOV edge 512, the camera system may activate the second camera 504 as well to prevent losing track of the fourth object 522 if it were to move from the first camera FOV 506 to the second camera FOV 508. The second camera 504 is activated in this case because the fourth object 522 is detected as being positioned within the threshold distance 512 of the FOV edge 510 of the first camera FOV 506 that is near the second camera FOV 508. If the fourth object 522 were instead located within a threshold distance 512 of the left edge of the first camera FOV 506, the camera system may indicate to the user that the fourth object 522 is about to leave the FOV of the system. the indication may comprise a push notification on the user’s client device, a visual indication on an augmented reality display, or an auditory indication from the speaker of the client device or the headset.

In some embodiments the camera system may be configured to focus on more than one object at a time. In this embodiment the camera system follows the same process as described above and processes video captured by a camera or cameras that contain the object within their FOV. For example, a first object may be within the FOV of a first camera and therefore a first video is generated using video frames of the first camera. Simultaneously, a second object may be within the FOV of a second camera and therefore a second video is generated using video frames from the second camera. If the first and second object switch positions, the first camera will capture the second object while the second camera will capture the first object, and the relevant video frames for each object will be incorporated into each video. The first video includes video frames capturing the first object while the second video includes video frames capturing the second object. If a single video frame captures both objects, the video frame may be incorporated into both videos.

FIG. 6 is a system 600 that includes a headset 605, in accordance with one or more embodiments. In some embodiments, the headset 605 may be the headset 100 of FIG. 1A or the headset 105 of FIG. 1B. The system 600 may operate in an artificial reality environment (e.g., a virtual reality environment, an augmented reality environment, a mixed reality environment, or some combination thereof). The system 600 shown by FIG. 6 includes the headset 605, the client device 615, the network 620, and the server 625. While FIG. 6 shows an example system 600 including one headset 605, in other embodiments any number of these components may be included in the system 600. In alternative configurations, different and/or additional components may be included in the system 600. Additionally, functionality described in conjunction with one or more of the components shown in FIG. 6 may be distributed among the components in a different manner than described in conjunction with FIG. 6 in some embodiments. For example, some or all of the functionality of the client device 615 may be provided by the headset 605.

The headset 605 includes the display assembly 630, an optics block 635, one or more position sensors 640, and the DCA 645. Some embodiments of headset 605 have different components than those described in conjunction with FIG. 6. Additionally, the functionality provided by various components described in, conjunction with FIG. 6 may be differently distributed among the components of the headset 605 in other embodiments or be captured in separate assemblies remote from the headset 605.

The display assembly 630 displays content to the user in accordance with data received from the client device 615. The display assembly 630 displays the content using one or more display elements (e.g., the display elements 120). A display element may be, e.g., an electronic display. In various embodiments, the display assembly 630 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 635.

The optics block 635 may magnify image light received from the electronic display, corrects optical errors associated with the image light, and presents the corrected image light to one or both eyeboxes of the headset 605. In various embodiments, the optics block 635 includes one or more optical elements. Example optical elements included in the optics block 635 include: an aperture, a Fresnel lens, a convex lens, a concave lens, a filter, a reflecting surface, or any other suitable optical element that affects image light. Moreover, the optics block 635 may include combinations of different optical elements. In some embodiments, one or more of the optical elements in the optics block 635 may have one or more coatings, such as partially reflective or anti-reflective coatings.

Magnification and focusing of the image light by the optics block 635 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user’s field of view. Additionally, in some embodiments, the amount of magnification may be adjusted by adding or removing optical elements.

In some embodiments, the optics block 635 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 635 corrects the distortion when it receives image light from the electronic display generated based on the content.

The position sensor 640 is an electronic device that generates data indicating a position of the headset 605. The position sensor 640 generates one or more measurement signals in response to motion of the headset 605. The position sensor 190 is an embodiment of the position sensor 640. Examples of a position sensor 640 include: one or more IMUs, one or more accelerometers, one or more gyroscopes, one or more magnetometers, another suitable type of sensor that detects motion, or some combination thereof. The position sensor 640 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 605 from the sampled data. For example, the IMU integrates the measurement signals received from the accelerometers over time to estimate a velocity vector and integrates the velocity vector over time to determine an estimated position of a reference point on the headset 605. The reference point is a point that may be used to describe the position of the headset 605. While the reference point may generally be defined as a point in space, however, in practice the reference point is defined as a point within the headset 605.

The DCA 645 generates depth information for a portion of the local area. The DCA includes one or more imaging devices and a DCA controller. The DCA 645 may also include an illuminator. Operation and structure of the DCA 645 is described above with regard to FIG. 1A.

The camera system 650 provides image or video content to a user of the headset 605. The camera system 650 is substantially the same as the camera system 200 described above. The camera system 650 may comprise one or more imaging devices and a camera controller. The camera system 650 may provide information describing at least a portion of the local area from e.g., the DCA 645 and/or location information for the headset 605 from the position sensor 640. The camera system 650 is configured to generate image or video content of a tracked object selected by a user of the headset 605.

The client device 615 communicates with the headset 605 via the network 620. the client device may be a smart phone, laptop, tablet, smart watch, or other mobile device. The client device 615 hosts an application 655 associated with the headset 605. The application 655 may perform actions associated with choosing an object for the camera system 650 of the headset 605 to track. For example, a user of the client device 615 may point their phone camera at an object and select the object within the application 655 associated with the headset 605. The application 655 processes the image containing selected object and transmits instructions to the headset 605 indicating which object the camera system 650 of the headset should track. In other embodiments, the client device 615 may display a stream of the video captured by the camera system 650 through the application 655. In this embodiment, the user of the client device 615 may select an object within the field of view of a camera of the camera system 650 and indicate that the camera system should tracking the object and generate a video of the object. The client device 615 and application 655 can further be used to indicate to the headset 605 to power on or off and to stop or start recording video with the camera system 650. The application 655 may have an application store in which it can store videos of tracked objects. The videos may also be uploaded to the server 625 through network 620 for cloud storage. In some embodiments location services of the client device 615 may be queried by the application 655 to indicate the location of the client device 615 relative to the headset 605. Other modules of the client device 615 such as an accelerometer may additionally be queried by the application 655. In some embodiments, the functionality discussed herein with respect to the client device 615 may be implemented in the headset 605, or a remote system. Similarly, some or all of the functionality performed by the controller of the camera system 650 of the headset 605 may be performed by the client device 615.

The network 620 couples the headset 605 and/or the client device 615 to the server 625. The network 620 may include any combination of local area and/or wide area networks using both wireless and/or wired communication systems. For example, the network 620 may include the Internet, as well as mobile telephone networks. In one embodiment, the network 620 uses standard communications technologies and/or protocols. Hence, the network 620 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 620 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 620 can be represented using technologies and/or formats including image data in binary form (e.g., Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The server 625 may include a database that stores a virtual model describing a plurality of spaces, wherein one location in the virtual model corresponds to a current configuration of a local area of the headset 605. The server 625 receives, from the headset 605 via the network 620, information describing at least a portion of the local area and/or location information for the local area. The user may adjust privacy settings to allow or prevent the headset 605 from transmitting information to the server 625. The server 625 determines, based on the received information and/or location information, a location in the virtual model that is associated with the local area of the headset 605. The server 625 determines (e.g., retrieves) one or more parameters associated with the local area, based in part on the determined location in the virtual model and any acoustic parameters associated with the determined location. The server 625 may transmit the location of the local area and any values of parameters associated with the local area to the headset 605.

One or more components of system 600 may contain a privacy module that stores one or more privacy settings for user data elements. The user data elements describe the user or the headset 605. For example, the user data elements may describe a physical characteristic of the user, an action performed by the user, a location of the user of the headset 605, a location of the headset 605, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 600 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A headset, comprising:
a first camera;
a second camera having; and
a controller configured to:
receive an instruction to generate a video having a focus on an object,
identify a position of the object in a first video frame captured by the first camera,
determine that the object is out of focus in the first video frame based on the position of the object in the first video frame,
adjust the position of the object within the first video frame,
incorporate the first video frame captured by the first camera into the video,
monitor a position of the object in a field of view of the first camera,
monitor a position of the object in a field of view of the second camera, and
responsive to determining that the positions of the object in the field of views of the first and second cameras satisfy one or more conditions, activate the second camera to capture a second video frame, and incorporate the second video frame captured by the second camera into the video.

2. The headset of claim 1, wherein at least one of a movement of the first camera or a movement of the object causes the object to be out of focus in the first video frame.

3. The headset of claim 1, wherein adjusting the position of the object within the first video frame includes modifying the first video frame so that the position of the object is within a threshold distance of a center of the first video frame.

4. The headset of claim 1, wherein the one or more conditions comprises that the object is within a threshold distance of a first edge of the field of view of the first camera
.

5. The headset of claim 4, wherein the controller is further configured to:
responsive to the object being within a threshold distance of the first edge of the first video frame, activate the second camera; and
responsive to the object being outside of the field of view of the first camera, deactivating the first camera.

6. The headset of claim 5, wherein the controller is further configured to:
responsive to the object being within a threshold distance of a second edge of a second fieldof view of the second camera, activate the first camera.

7. The headset of claim 1, wherein the controller configured to identify the position of the object in the first video frame includes the controller being configured to identify that the object reenters the field of view of the first camera after the object leaves the field of view of the first camera.

8. The headset of claim 1, further comprising a display and wherein the controller is further configured to display a visual indication of the object on the display in response to receiving the instruction to generate the video having a focus on the object.

9. The headset of claim 1, wherein the controller is further configured to stream the generated video to a mobile device associated with the headset, and wherein the instruction to generate the video having the focus on the object is received from the mobile device.

10. The headset of claim 5, wherein the controller is further configured to instruct the headset to provide haptic feedback responsive to one or more of the object leaving the field of view of the first or second camera or the object re-entering the field of view of the-first or second camera.

11. A method comprising:
receiving, by a headset having a first camera and a second camera, an instruction to generate a video having a focus on an object;
identifying a position of the object in a first video frame captured by the first camera of the headset;
determining that the object is out of focus in the first video frame based on the position of the object in the video frame;
adjusting the position of the object within the first video frame;
incorporating the first video frame captured by the first camera into the video;
monitoring a position of the object in a field of view of the first camera,
monitoring a position of the object in a field of view of the second camera, and
responsive to determining that the positions of the object in the field of views of the first and second cameras satisfy one or more conditions,
activating the second camera to capture a second video frame, and
incorporating the second video frame captured by the second camera into the video.

12. The method of claim 11, wherein at least one of a movement of the first camera or a movement of the object causes the object to be out of focus in the first video frame.

13. The method of claim 11, wherein adjusting the position of the object within the first video frame includes modifying the first video frame so that the position of the object is within a threshold distance of a center of the first video frame.

14. The method of claim 11, wherein the one or more conditions comprises that the object is within a threshold distance of a first edge of the field of view of the first camera.

15. The method of claim 14, further comprising:
responsive to the object being within a threshold distance of the first edge of the first field of view of the first camera, activating the second camera; and
responsive to the object being outside of the field of view of the first camera, deactivating the first camera.

16. The method of claim 11, wherein identifying the position of the object in the first video frame further comprises storing an identifier of the object to enable re-focusing on the object if the object re-enters the field of view of the first camera after the object leaves the field of view of the first camera.

17. The method of claim 11, wherein the headset further comprises a visual display, further comprising:
responsive to receiving the instruction to generate the video, displaying a visual indication of the object on the visual display.

18. The method of claim 11, wherein the headset lacks a visual display, further comprising:
streaming the generated video to a mobile device associated with the headset; and
displaying a visual indication of the object on the mobile device.

19. The method of claim 11, further comprising:
providing haptic feedback responsive to one or more of the object leaving a field of view of the headset, or the object re-entering the field of view of the first or second camera.

20. A non-transitory computer readable medium comprising stored instructions that when executed by one or more processors of a system having a first camera and a second camera, configure the system to:
receive an instruction to generate a video having a focus on an object;
identify a position of the object in a first video frame captured by the first camera;
determine that the object is out of focus in the first video frame based on the position of the object in the first video frame;
adjust the position of the object within the first video frame;
incorporate the first video frame captured by the first camera into the video;
monitor a position of the object in a field of view of the first camera;
monitor a position of the object in a field of view of the second camera; and
responsive to determining that the positions of the object in the field of views of the first and second cameras satisfy one or more conditions,
activate the second camera to capture a second video frame; and
incorporate the second video frame captured by the second camera into the video.
